(19) United States
(12) Patent Application Publication
(10) Pub. No.: US 2002/0003580 A1
(43) Pub. Date: Jan. 10, 2002

(54) Line image sensor module

(76) Inventor: Minoru Yoshida, Osaka (JP)

Correspondence Address: MERCHANT & GOULD PC, P.O. BOX 2903, MINNEAPOLIS, MN, 55402-0903, US

(21) Appl. No.: 09/876,686

(22) Filed: Jun. 7, 2001

(30) Foreign Application Priority Data
Jun. 16, 2000 (JP) 2000-180862

(51) Int. Cl. H04N 3/14; H04N 5/335

(52) U.S. Cl. 348/324

(57) ABSTRACT

A coating film 9 is formed on a light guide-mounting portion of a frame 2. This coating film 9 presents a color reflecting light over a wide range of wavelength such as a white color. Instead of forming the coating film 9, a light guide 3 can also be mounted through a thin paper-shaped member such as a white-colored paper or a silver-colored paper that allows light to reflect. The coating film or the thin paper-shaped member can be provided not only on the bottom surface of the light guide-mounting portion of the frame 2, but also on the side thereof.

### BACKGROUND OF THE INVENTION

1. Field of the Invention

The present invention relates to a contact-type line image sensor module (an image-reading device).

2. Description of the Prior Art

A contact-type line image sensor module has a smaller number of parts compared with a line image sensor module using a reducing optical system, and a sensor and a lens array which are optical components can also be arranged closely. Accordingly, there is an advantage that the contact-type line image sensor module can be comparatively made thin. Thus, the contact-type line image sensor module is used as equipment for reading a document in a facsimile machine, a copying machine, a scanner and the like.

FIG. 7 is a cross-sectional view of a conventional line image sensor module (an image reading device). The conventional line sensor module 101 is provided with a frame 102 in which a light guide casing 104 housing a light guide 103 therein is installed. A lens array 105 is disposed within the frame 102 on the upper part of which a cover glass 106 is mounted. Mounted on the lower part of the frame 102 is a base plate 108 which is provided with a line image sensor (a photoelectric conversion element) 107. A reference numeral 109 is a bonding wire for electrically connecting an output electrode of the line image sensor (the photoelectric conversion element) 107 to an electrode on the side of the base plate 108.

The line sensor module 101 allows illuminating light emitted from an emission plane of the light guide 103 to enter a reading surface of a document through the cover glass 106. The light reflected from the reading surface is then detected by the line image sensor (the photoelectric conversion element) 107 through the rod lens array 105 and thus, the document is read.

The light guide 103 is, as shown in FIG. 8., housed in, for example, a white-colored light guide casing 104 so as to expose the emission plane 103a. In this manner, by covering the light guide 103 with the light guide casing 104, fractions of light coming outside are caused to reflect by the light guide casing 104 so as to return them to the inside of the light guide 103. Thus, it is possible to decrease loss of scattered light and improve the intensity of emission light.

A light-emitting source base plate 111 provided with a light-emitting source consisting of an LED or the like is attached to one end of the light guide casing 104.

The conventional line image sensor module is provided with the light guide casing to make good use of the fractions of light leaking from the light guide. this means that the sensor module must be larger in proportion to the thickness of the light guide casing. A process for housing the light guide within the light guide casing is also required. Further, the light guide casing becomes comparatively expensive because it must be made to fit the shape of the light guide.

### SUMMARY OF THE INVENTION

It is therefore an object of the present invention to solve those problems and to provide a line image sensor module which can increase the intensity of an emission light without provision of a light guide casing.

To attain the above-mentioned object according to the present invention, a line image sensor module is provided, which comprises a frame, a rod-shaped light guide adapted to emit light from a light-emitting source toward a document, a line image sensor provided with a plurality of photoelectric conversion elements, and a rod lens array for converging light reflected from the document on the line image sensor, the rod-shaped light guide, the line image sensor and the rod lens array being housed within the frame, characterized in that the rod-shaped light guide is directly installed in the. frame, and a reflecting body consisting of a thin paper-shaped member, a coating film or the like for reflecting light in a visible light range is provided on at least a portion of a side of the frame contacting a reflecting side of the rod-shaped light guide.

For example, a white or silver-colored thin paper is provided on the side of the frame contacting the reflecting side of the rod-shaped light guide. It is therefore possible to allow fractions of the light coming through the light guide to reflect at the light guide and to return them inside of the light guide. With this construction, loss of scattered light is reduced and the intensity of light emitted from the emission plane improves.

The above and other objects, features and advantages of the present invention will become more apparent from the following description when taken in conjunction with the accompanying drawings.

### BRIEF DESCRIPTION OF THE DRAWINGS

FIG. 1 is a plan view of a line image sensor module according to the present invention;

FIG. 2 is an enlarged cross-sectional view taken along line A-A of FIG. 1;

FIG. 3 is a cross-sectional view of another line image sensor module according to the present invention;

FIG. 4 is a view showing one example of light-scattering patterns formed on a rod-shaped light guide;

FIG. 5 is a graph comparatively showing change of an amount of light between the present invention and the prior art;

FIG. 6 is a graph comparatively showing PRNU (Photo Response Non-Uniformity) between the present invention and the prior art;

FIG. 7 is a cross-sectional view of a conventional line sensor module; and

FIG. 8 is an exploded perspective view of a casing and a rod-shaped light guide of the prior art.

### DETAILED DESCRIPTION OF THE PREFERRED EMBODIMENTS

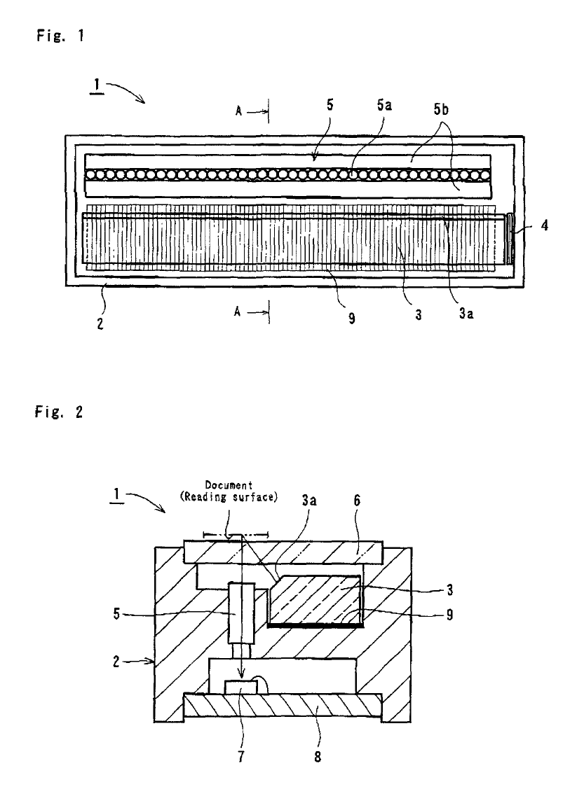

Preferred embodiments of the present invention will now be described with reference to the accompanying drawings. FIG. 1 is a plan view of a line image sensor module according to the present invention and FIG. 2 is a cross-sectional view of the same module.

A line image sensor nodule 1 is composed of a frame 2, a rod-shaped light guide 3, a light-emitting source (LED) 4, a rod lend array 5, a cover glass 6, a line image sensor 7 and a base plate 8. The rod lens array 5 consists of many rod lenses 5a of which both ends are held between resin plates 5b and 5b, and black resins are filled between the rod lenses 5a.

A reflecting body 9 is provided at the bottom surface of a light guide-mounting portion of the frame 2. It is desirable to make this reflecting body 9 with a white or silver-colored thin paper or the like, The reflecting body 9 can also be formed by roller printing, spray coating or by taping.

The reflecting body 9 can be formed not only on the bottom surface, but also on the bottom and side surfaces of the light guide-mounting portion of the frame 2 in an L-shape as shown in FIG. 3.

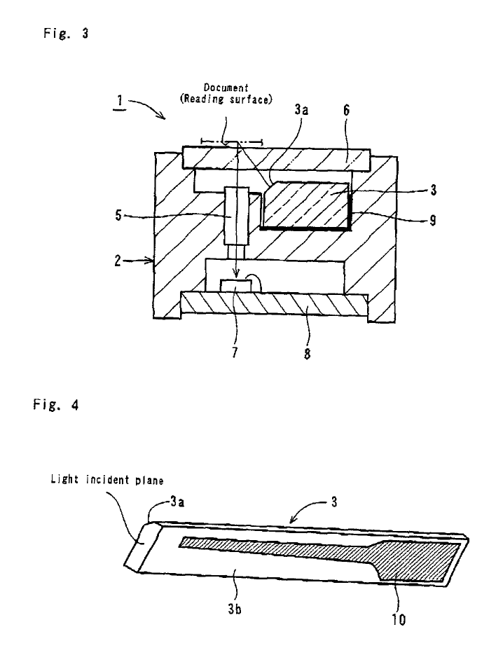

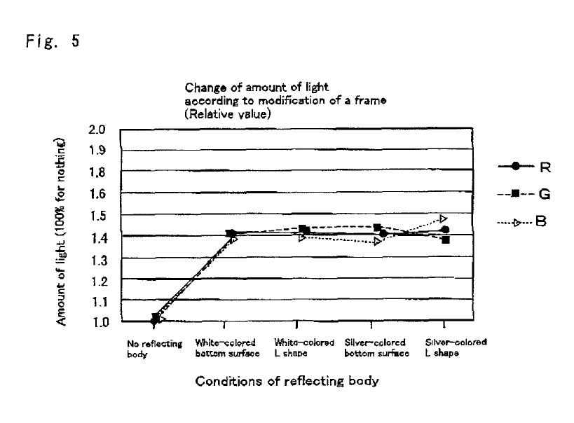

On the other hand, as shown in FIG. 4, a light-scattering pattern 10 is formed On the back of the rod-shaped light guide 3 in such a manner that one side of the pattern near the light-emitting source (LED) 4 is narrowed or discontinuous, while the width of the pattern is gradually broadened toward the other end away from the light-emitting source 4. By forming this light-scattering pattern 10, the amount of light irradiated in the longitudinal direction can be uniformed.

As a means for forming the light-scattering patterns 10, in addition to application of white paints, an uneven surface can be formed or the designated area of the back of the rod-shaped light guide 3 can be roughened by a laser beam.

Further, the reflecting body 9 and the thin paper-shaped member are not always formed in the same width, but they may be narrowed or discontinuous at one end near the light-emitting source (LED) 4 and gradually broadened toward the other end in proportion to the shape of light-scattering patterns 10.

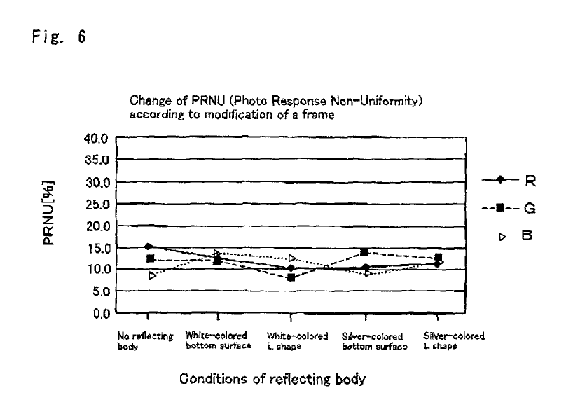

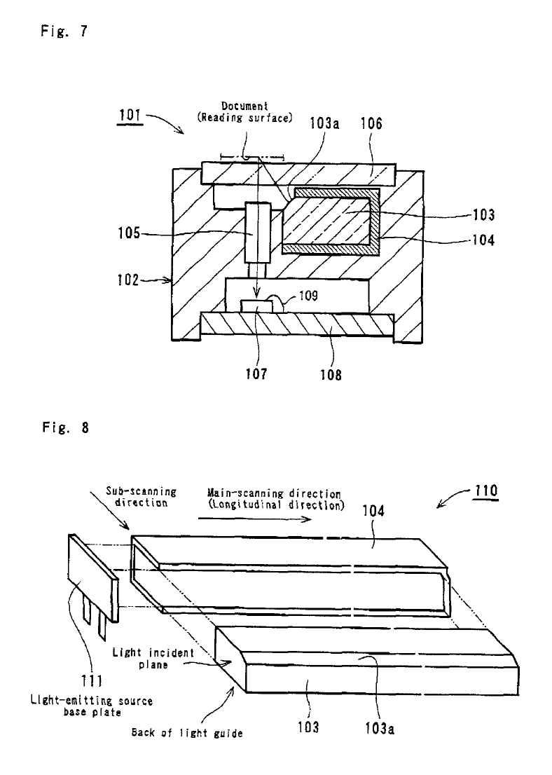

Comparative results of the change of amount of light and PRNU (Photo Response Non-Uniformity) which shows deviation of intensity of illumination between the lime image sensor module according to the present invention and the prior art will now be described with reference to FIGS. 5 and 6.

If relative intensity of the amount of light emitted from the document-reading surface of the prior art (with the light guide casing) shown in FIG. 7 is 100, the relative intensity of the amount of emission light when the light guide casing 104 is removed and the light guide 103 is directly install at the light guide-mounting portion become 50-65 for each of R (red), G (green) and B (Blue). Thus, the amount of light decreases drastically.

On the other hand, as shown in FIG. 2, by gluing white-colored synthetic papers (for example, YUPO paper made by YUPO CORPORATION) to the bottom surface of the light guide-mounting portion of the frame 2, it is possible to allow fractions of the light coming through the back of the light guide 3 to reflect at the synthetic papers (the reflecting body 9) and to return them to the inside of the light guide 3. In this case, the relative intensity of the amount of the emission light becomes 80-90, and even though the light guide casing is removed, it is possible to obtain practically sufficient amount of emission light.

The amount of emission light depends on the kind of the light-scattering patterns of thc light guide as mentioned above. However, when the white-colored synthetic papers are provided on the bottom surface of the light guide-mounting portion, the amount of light emitted became 1.2-1.3 times as much as that of when the white-colored papers arc not provided thereon (i.e. the light guide 3 is directly installed in position). Silver-colored synthetic papers can also be used in which the performance equivalent to or slightly higher than the white-colored papers is obtained. FIG. 5 shows the degree of improvement of the amount of light on the surface of the document relative to the conditions of the reflecting body when the light-scattering pattern with the unevenness formed on the surface of the light guide is used. Assuming that the amount of light when the reflecting body is not provided is 1, the amount of light when the white-colored synthetic papers are provided on the bottom or in an L-shape position shows the improvement of about 1.4 times without depending on a wavelength of light (R, G, and B) so much. The silver-colored synthetic papers slightly depend on the wavelength, but the amount of light is equivalent to or slightly larger than the white-colored papers.

FIG. 6 shows the change of deviation of intensity of illumination (PRNTU) relative to the condition of the reflecting body in a similar way as FIG. 5. The PRNU is defined by the following expression.

PRNU=(Imax−Imin)/(Imax+Imin)×100%

It is observed that the PRNU does not deteriorate so much compared with a case where the reflecting body is not provided and it hardly depends on the conditions of the wavelength and the reflecting body.

As described above, according to the present invention, a coating film is provided on the mounting portion of a light guide or a thin paper-shaped member reflecting the light is provided between the light guide-mounting portion and the light guide. Accordingly, it is possible to allow fractions of the light leaking outside of the light guide from the back or side of the light guide to reflect by the coating film or the thin paper-shaped member and return the light to the inside of the light guide. In this manner, it is possible to make good use of the light from the light-emitting Source and improve the intensity of light emitted from the emission plane of the light guide. Thus, even though the light guide casing is removed, it is possible to obtain practically sufficient intensity of emission light and make the line image sensor module compact by the size of the light guide casing. It is further possible to provide a lower-priced line image sensor module.

What is claimed is:

1. A line image sensor module comprising:
a frame;
a rod-shaped light guide adapted to emit light from a light-emitting source toward a document;
a line image sensor provided with a plurality of photoelectric conversion elements; and
a lens array for converging light reflected from the document on the line image sensor;
the rod-shaped light guide, the line image sensor and the lens array being installed in the frame;
characterized in that the rod-shaped light guide is directly installed within the frame, and a reflecting body for reflecting light in a visible light range is formed on at least a portion of the side of the frame contacting the reflecting side of the rod-shaped light guide.

2. The line image sensor module according to claim 1, wherein the reflecting body is a thin paper-shaped member or a coating film.
